(19) United States
(12) Patent Application Publication
(10) Pub. No.: US 2010/0320708 A1
(43) Pub. Date: Dec. 23, 2010

(54) SYSTEM AND METHOD OF TRANSPORTING AND POSITIONING A DEPLOYABLE PREFABRICATED STRUCTURE

(75) Inventor: James D. Pope, San Francisco, CA (US)

Correspondence Address: FLIESLER MEYER LLP, 650 CALIFORNIA STREET, 14TH FLOOR, SAN FRANCISCO, CA, 94108, US

(73) Assignee: GREEN HORIZON MANUFACTURING LLC, San Francisco, CA (US)

(21) Appl. No.: 12/708,023

(22) Filed: Feb. 18, 2010

Related U.S. Application Data
(60) Provisional application No. 61/157,016, filed on Mar. 3, 2009.

(51) Int. Cl. E04B 1/343; E04H 1/00; B62D 63/06

(52) U.S. Cl. 280/30; 52/67; 52/79.1

(57) ABSTRACT

A portable, prefabricated structure comprises a frame and a pair of guide rails extending below the frame and along at least a portion of a length of the frame. Each guide rail includes a channel. The structure further comprises a carriage stop within the channels of the pair of guide rails, a carriage including at least one pair of wheels connected with the carriage and a carriage lip received within the channels of the pair of guide rails, the carriage movably associated with the pair of guide rails by urging the carriage lip along the channels, and an anchor connected to the carriage by a hinge, the anchor movable with the carriage by urging the anchor along the channels of the pair of guide rails. When configured for transport by way of the wheels, the anchor is urged against the carriage stop and when deployed at a target site, the carriage is extendable outside of the channels of the pair of guide rails and the anchor is lockable within the channels so that the carriage is rotatable at the hinge such that the carriage is substantially perpendicular to the pair of guide rails.

### CLAIM OF PRIORITY

This application claims benefit to the following U.S. Provisional Patent Application:

U.S. Provisional Patent Application No. 61/157,016, entitled “System and Method of Transporting and Positioning a Deployable Prefabricated Structure,” by James D. Pope, Attorney Docket No. POPE-01002US0, filed Mar. 3, 2009.

### TECHNICAL FIELD

This invention relates to prefabricated structures and mechanisms for transporting prefabricated structures.

### BACKGROUND

Recent catastrophic events, such as Hurricane Katrina and the Boxing Day Tsunami of 2004 have demonstrated a persisting need for prefabricated structures that can be easily and quickly deployed to disaster sites that do not necessarily have access to preexisting utilities and that can provide multiple logistical services to victims. Prefabricated structures suited for easy and quick deployment can further be used in other settings where preexisting utilities may not be present for temporary use such as at construction sites, or for more permanent use, such as at remote, undeveloped homestead.

### BRIEF DESCRIPTION OF THE FIGURES

FIG. 1 is a rear-facing perspective view of an embodiment of a prefabricated structure in accordance with the present invention comprising a wheeled carriage and hitch carriage.

FIG. 2A is a detailed perspective view of a guide rails and wheeled carriage assembly for use with embodiments of prefabricated structures in accordance with the present invention of FIG. 1.

FIG. 2B is a perspective view of the guide rails and wheeled carriage assembly of FIG. 2A, with the wheeled carriage partially extended from the guide rails.

FIG. 2C is a perspective view of the guide rails and wheeled carriage assembly of FIGS. 2A and 2B, with the wheeled carriage fully extended from the guide rails and partially rotated about a hinge connecting the wheeled carriage to an anchor plate.

FIG. 3A is a detailed perspective view of a guide rails and hitch carriage assembly for use with embodiments of prefabricated structures in accordance with the present invention of FIG. 1.

FIG. 3B is a perspective view of the guide rails and hitch carriage assembly of FIG. 3A, with the hitch carriage fully extended from the guide rails.

FIG. 3C is a perspective view of the guide rails and wheeled carriage assembly of FIGS. 3A and 3B, with the hitch carriage fully extended from the guide rails and partially rotated about a hinge connecting the hitch carriage to an anchor plate.

FIG. 4 is a rear-facing perspective view of an alternative embodiment of a prefabricated structure in accordance with the present invention comprising a wheeled carriage and hitch carriage.

FIG. 5 is a front-facing perspective view of a further embodiment of a prefabricated structure in accordance with the present invention comprising a wheeled carriage and hitch carriage, the perspective view illustrating an extension deployed from a frame of a shell of the prefabricated structure.

FIGS. 6A-6D are perspective views of an embodiment of a prefabricated structure and a method of deploying the prefabricated structure in accordance with the present invention.

FIG. 6A illustrates the prefabricated structure positioned for deployment at a target site; FIGS. 6B and 6C illustrate the prefabricated structure with support posts extended to fix the prefabricated structure in position; and FIG. 6D illustrates the prefabricated structure of with extension deployed.

### DETAILED DESCRIPTION

Common reference numerals are used throughout the drawings and detailed description to indicate like elements; therefore, reference numerals used in a drawing may or may not be referenced in the detailed description specific to such drawing if the associated element is described elsewhere.

Embodiments of prefabricated structures in accordance with the present invention can be quickly and efficiently positioned, anchored and deployed to reduce setup time, set up expense, and site preparation. Such embodiments can benefit structures intended for permanent use, emergency use such as for disaster relief, and/or for planned temporary use such as for classroom facilities and construction site administration.

Prefabricated structures, such as those described in U.S. Ser. No. 12/250,467, entitled “DEPLOYABLE PREFABRICATED STRUCTURE WITH A NESTED EXTENSION STRUCTURE” filed Oct. 13, 2008, incorporated by reference, can be deployed to sites accessible by different transportation modes, such as by road, by rail, by ship, or by air. Commonly, a more efficient technique for delivering a prefabricated structure to a site may include multiple transportation modes. Delivering a prefabricated structure to a site accessible by land over thousands of miles from a storage or construction location, for example, may be most efficiently achieved by a combination of rail and road, with transport by flatcar to a regional hub and transport by flatbed truck or semi-trailer to a staging site for final positioning by a forklift, crane, or other device. Delivering a prefabricated structure to a site overseas, for example to provide international humanitarian relief in the form of logistic centers and housing, may be most efficiently achieved by a combination of cargo ship, rail, and road, with transport by ship to an overseas hub, transport by flatcar to a regional hub and transport by flatbed truck or semi-trailer to a staging site for final positioning by a forklift, crane, or other device.

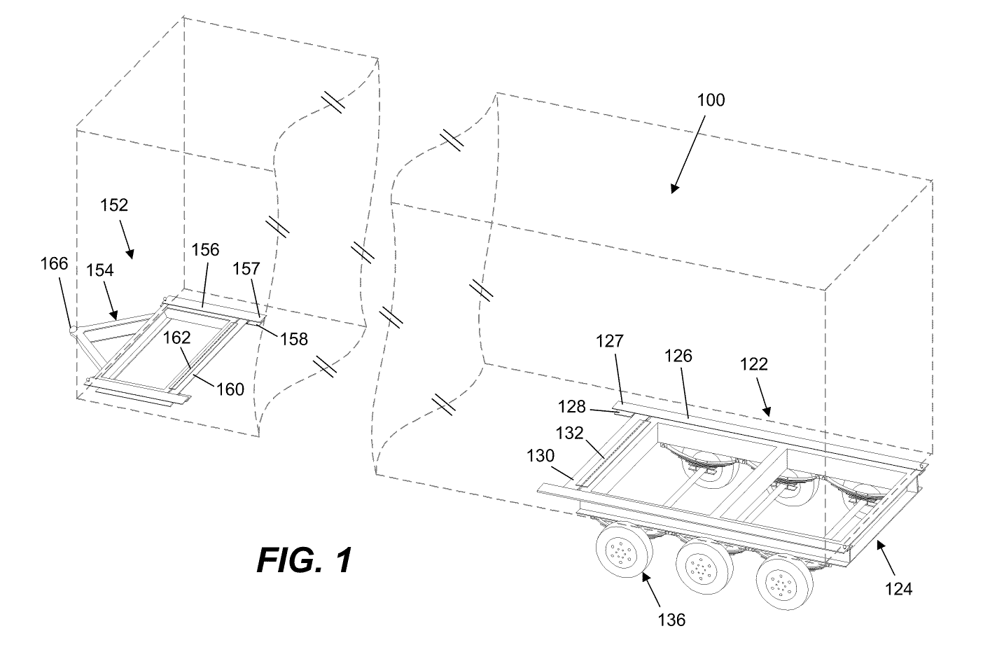

Transport of a prefabricated structure by road can be a common technique for transporting the prefabricated structure from a regional hub to a staging site. Referring to FIG. 1, embodiments of a portable, prefabricated structure 100 in accordance with the present invention can comprise a pair of carriages 122, 152 arranged beneath the prefabricated structure 100 and repositionable so that the pair of carriages 122, 152 are no longer beneath the prefabricated structure 100. The first carriage 122 is connected with three pairs of wheels 116 on which the prefabricated structure 100 can be transported. The second carriage 152 includes a hitch extending from the second carriage 152 to enable towing of the prefabricated structure 100.

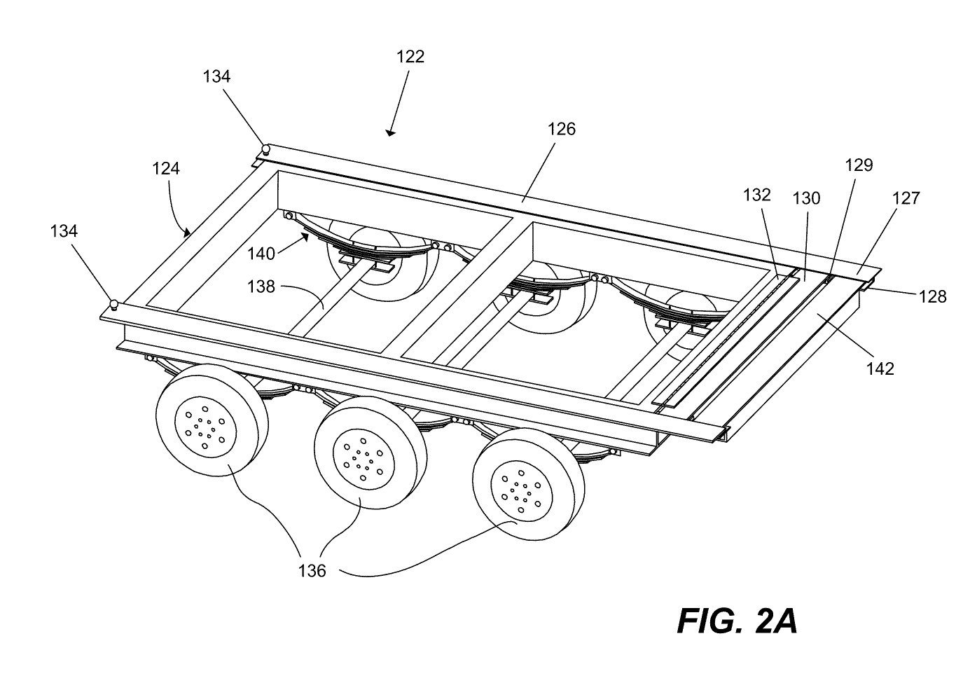

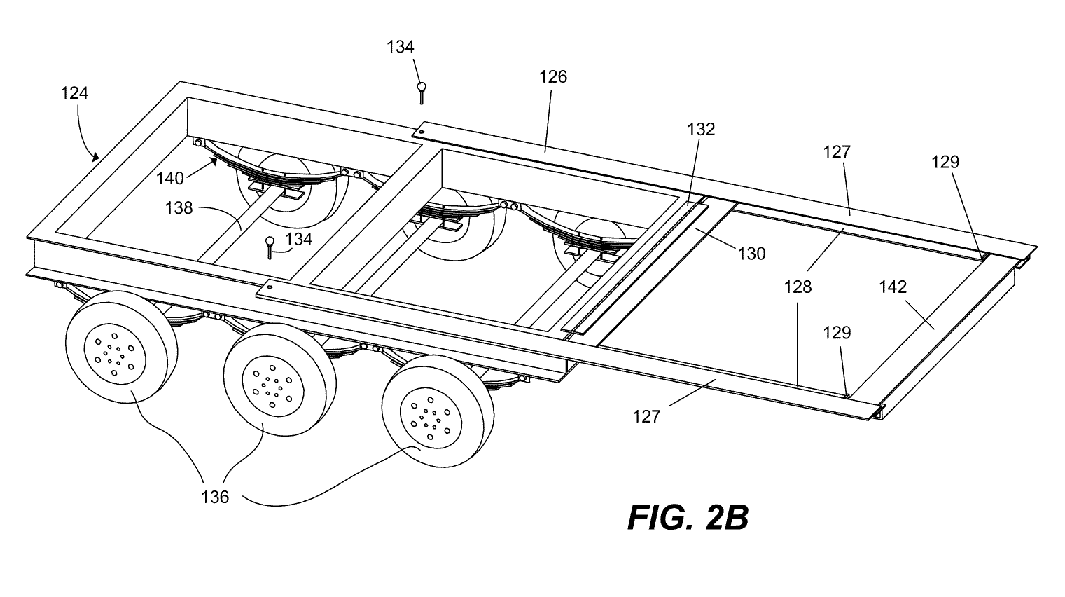

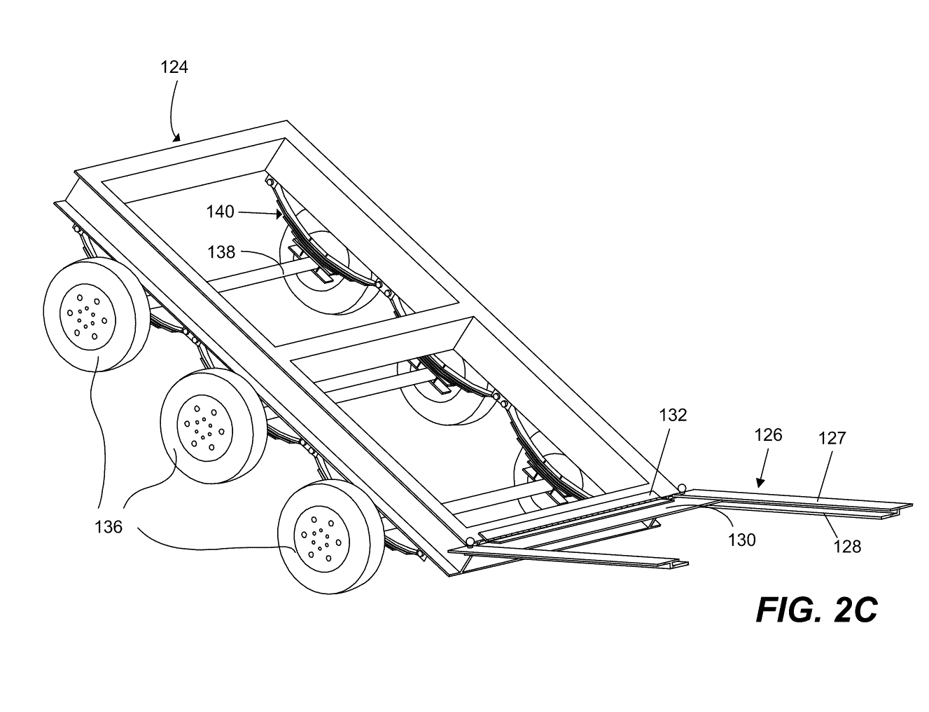

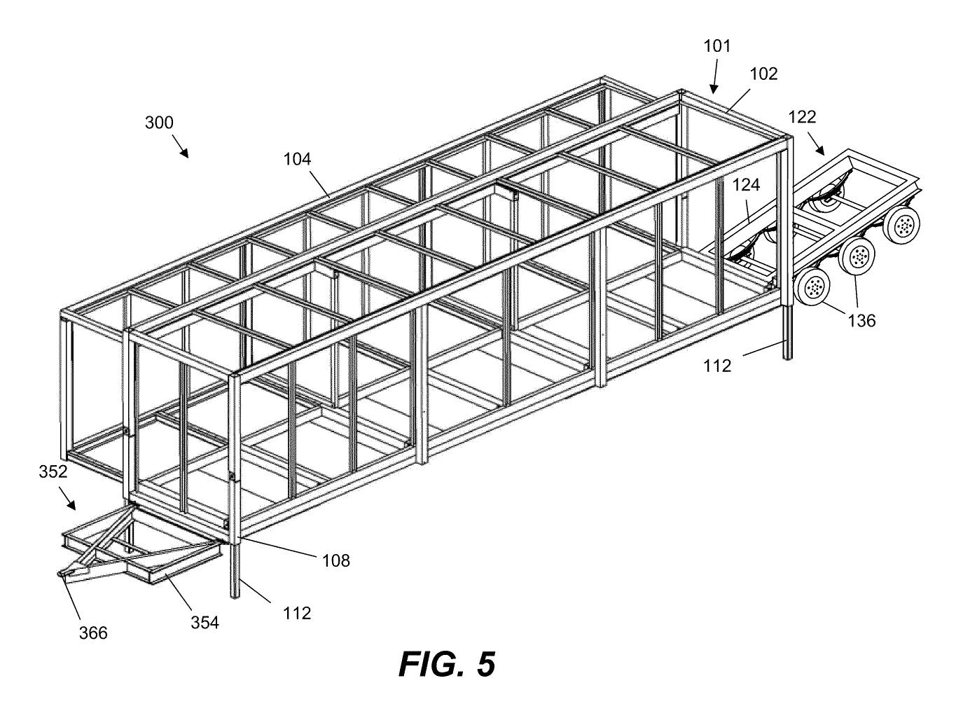

Referring to FIGS. 2A-2C, an assembly including the first carriage 122 and a first pair of guide rails 126 is shown in progressive stages of repositioning the first carriage 122 relative to the prefabricated structure. Each of the guide rails 126 includes a primary plate 127 fixedly associated with a frame (102, as shown in FIG. 5) of the prefabricated structure 100. For example, the primary plate 127 can be welded to the frame, bolted to the frame, or alternatively integrally formed with the frame (e.g. cast, extruded, or otherwise fabricated as a feature of the frame). A secondary plate 128 is connected with the primary plate 127 and gapped from the primary plate 127 to form a channel. The secondary plate 128 can be welded to the primary plate 127, bolted to the primary plate, or alternatively integrally formed with the primary plate 127. The pair of guide rails 126 extends from beneath the frame so that a first end of the pair of guide rails 126 is accessible. Removable locking pins 134 extend through the channels of the guide rails 126 at the first end to block movement within the channels. Further, a carriage stop 129 extends through at least a portion of the channel of the guide rails 126 near a second end of the guide rails 126 so that when the first carriage 122 is operably coupled with the guide rails 126, the first carriage 122 is positioned between the carriage stop 129 and the locking pins 134.

The first carriage 122 includes a carriage frame 124 having a lip (also referred to herein as a flange) 125. The lip 125 of the frame 124 is received within the channels of the guide rails 126 and can move within the channels of the guide rails 126. The removable locking pins 134 and carriage stops 129 limit movement of the lip 125 within the channels. As shown in FIG. 2B, with the locking pins 134 removed, the lip 125 (and first carriage 122) can be extended outside of the pair of guide rails 126. The carriage frame 124 is connected at a hinge 132 to an anchor plate 130. As the lip 125 of the carriage frame 124 is fully extended from the pair of guide rails 126, the removable locking pins 134 can be replaced to block movement of the anchor plate 130 within the channel of the pair of guide rails 126 and prevent the carriage frame 124 from being repositioned beneath the prefabricated structure 100. As shown in FIG. 2C, the carriage frame 124 can then be rotated at the hinge 128 so that the carriage frame 124 is arranged substantially perpendicular to the original orientation, possibly contacting and detachably fastened to a side of the prefabricated structure 100. Optionally, the first carriage 122 can be completely disassociated from the prefabricated structure 100 by removing the locking pins 134 and urging the anchor plate 130 from the channels of the guide rails 126.

As shown in FIGS. 1-2C, three pairs of wheels 136, each having corresponding axles 138, are connected to the first carriage 122 by leaf springs 140. However, in other embodiments more or fewer wheels can be connected with the first carriage and the wheels need not be connected with the first carriage by leaf springs. For example, the wheels can be connected with the carriage by coil springs, or alternatively may be undampened. Further, the anchor plate need not be a flat sheet, but alternatively could be a rod or other anchoring structure. The anchor plate can be connected with the first carriage by a structure other than a hinge, for example the first carriage can be connected with the anchor by one or more chains. Still further, in some embodiments a biased latch or other locking device can limit movement of the first carriage and anchor. A locking device need not necessarily be removable locking pins.

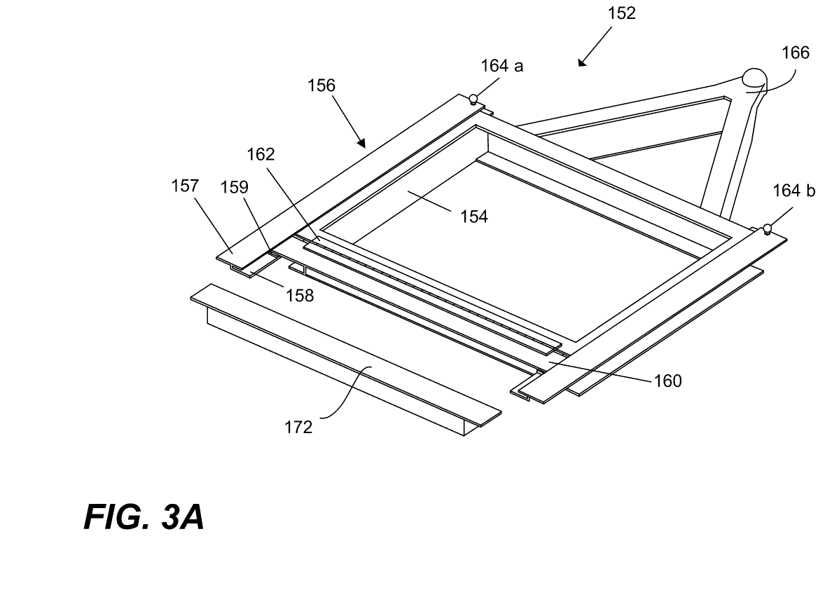

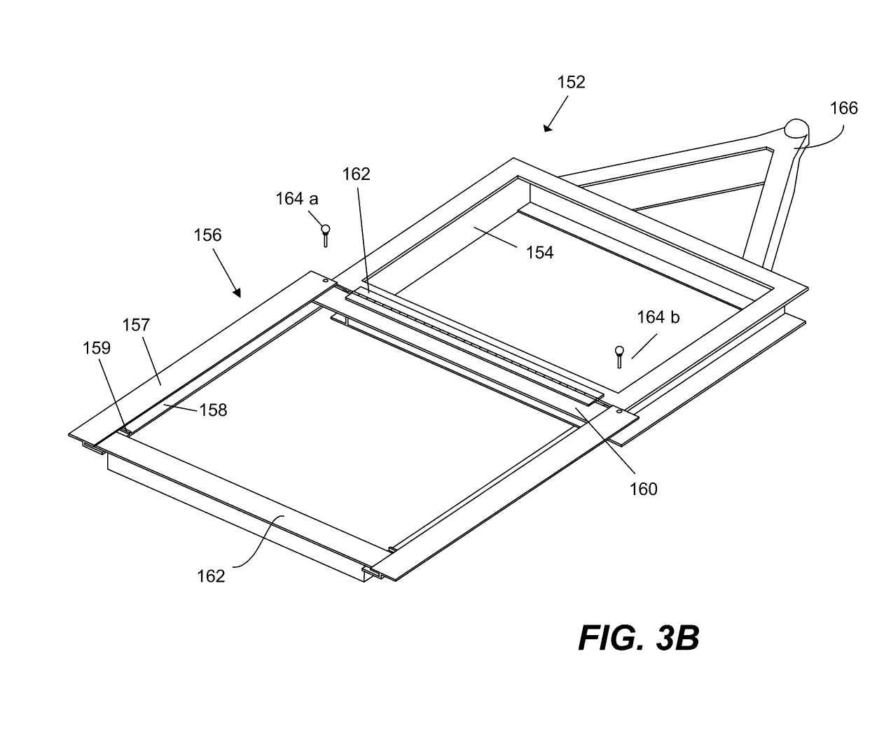

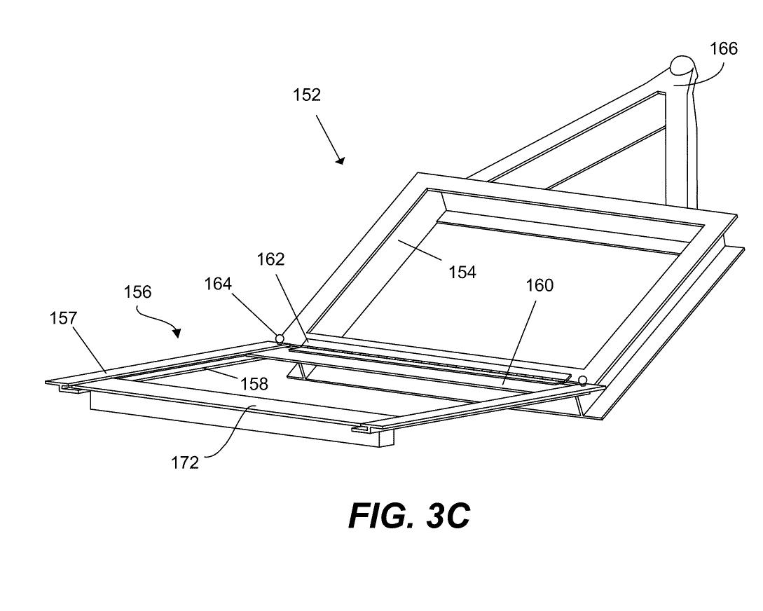

Referring to FIGS. 3A-3C, an assembly including a second carriage 152 and a second pair of guide rails 156 is shown in progressive stages of repositioning the first carriage 152 relative to the prefabricated structure. As with the first pair of guide rails, each of the guide rails 156 of the second pair includes a primary plate 157 fixedly associated with the frame of the prefabricated structure 100 and a secondary plate 158 is connected with the primary plate 157 and gapped from the primary plate 157 to form a channel. The pair of guide rails 156 extends from beneath the frame so that a first end of the pair of guide rails 156 is accessible. Removable locking pins 154 extend through the channels of the guide rails 156 at the first end to block movement within the channels. Further, a carriage stop 159 extends through at least a portion of the channel of the guide rails 156 nearer a second end of the guide rails 156 so that the first carriage is positioned between the carriage stop 159 and the locking pins 154.

The second carriage 152 includes a carriage frame 154 having a lip (also referred to herein as a flange) 155. The lip 155 of the frame 154 is received within the channels of the guide rails 156 and can move within the channels of the guide rails 156. The removable locking pins 154 and carriage stops 159 limit movement of the lip 155 within the channels. As shown in FIG. 3B, with the locking pins 164 removed, the lip 155 (and second carriage 152) can be extended outside of the pair of guide rails 156. The carriage frame 154 is connected at a hinge 162 to an anchor plate 160. As the lip 155 of the carriage frame 154 is fully extended from the pair of guide rails 156, the removable locking pins 164 can be replaced to block movement of the anchor plate 160 within the channel of the pair of guide rails 156, and further prevent the carriage frame 154 from being repositioned beneath the prefabricated structure 100. As shown in FIG. 3C, the carriage frame 154 can then be rotated at the hinge 158 so that the carriage frame 154 is substantially arranged perpendicular to the original orientation, possibly contacting and detachably fastened to a side of the prefabricated structure 100. Optionally, the second carriage 152 can be completely disassociated from the prefabricated structure by removing the locking pins 164 and urging the anchor plate 160 from the channels of the guide rails 156.

In other embodiments, the anchor plate 160 need not be a flat sheet, but alternatively could be a rod or other anchoring structure. Further, the anchor plate can be connected with the first carriage by a structure other than a hinge, for example the first carriage can be connected with the anchor by one or more chains. Still further, in some embodiments a biased latch or other locking device can limit movement of the first carriage and anchor. A locking device need not necessarily be removable locking pins.

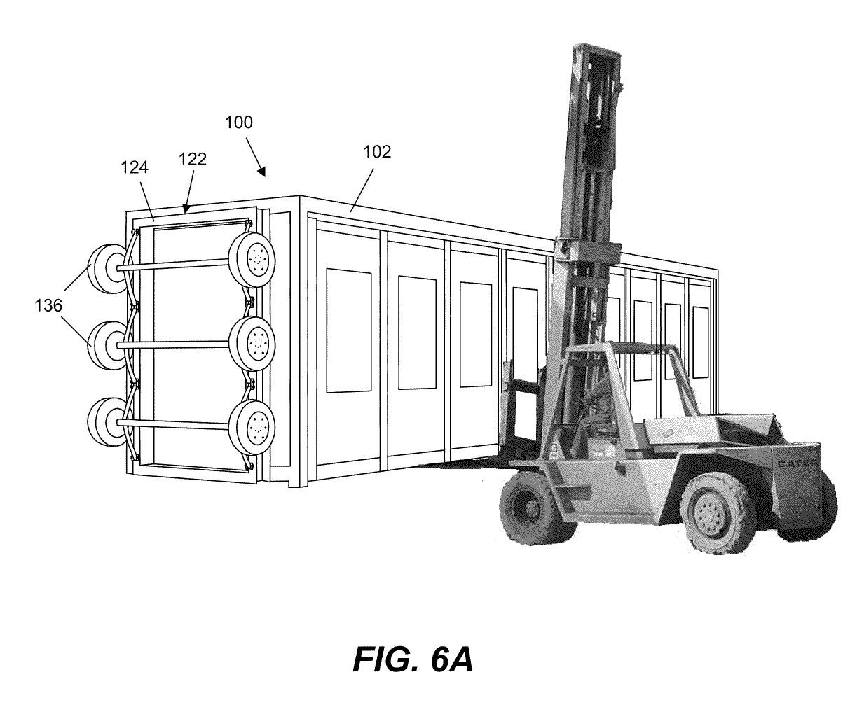

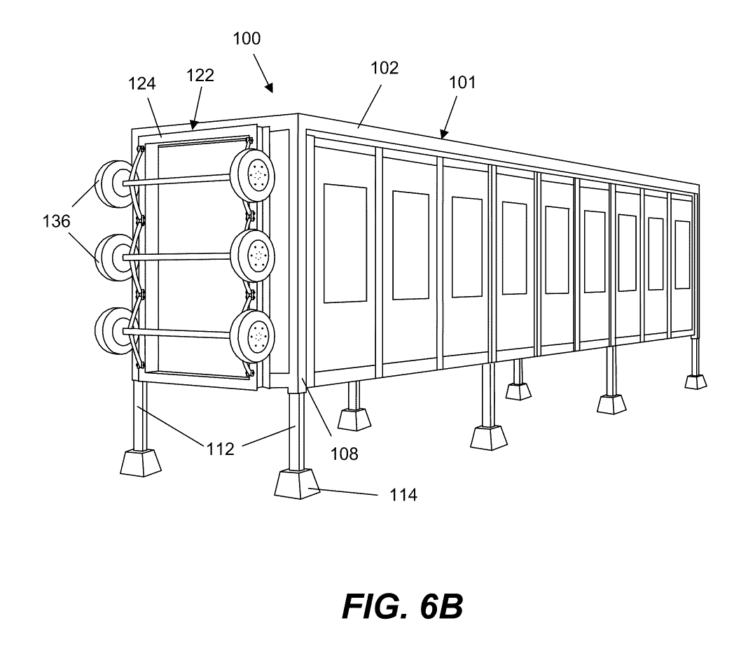

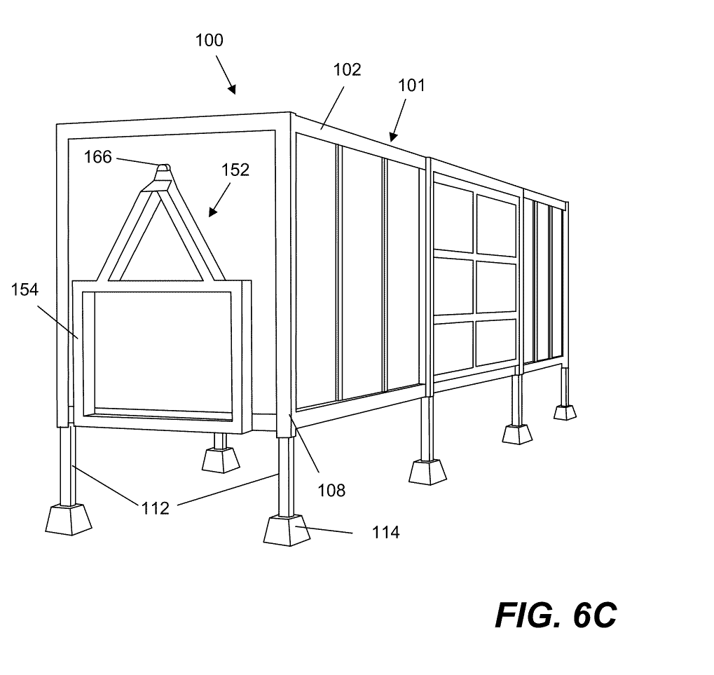

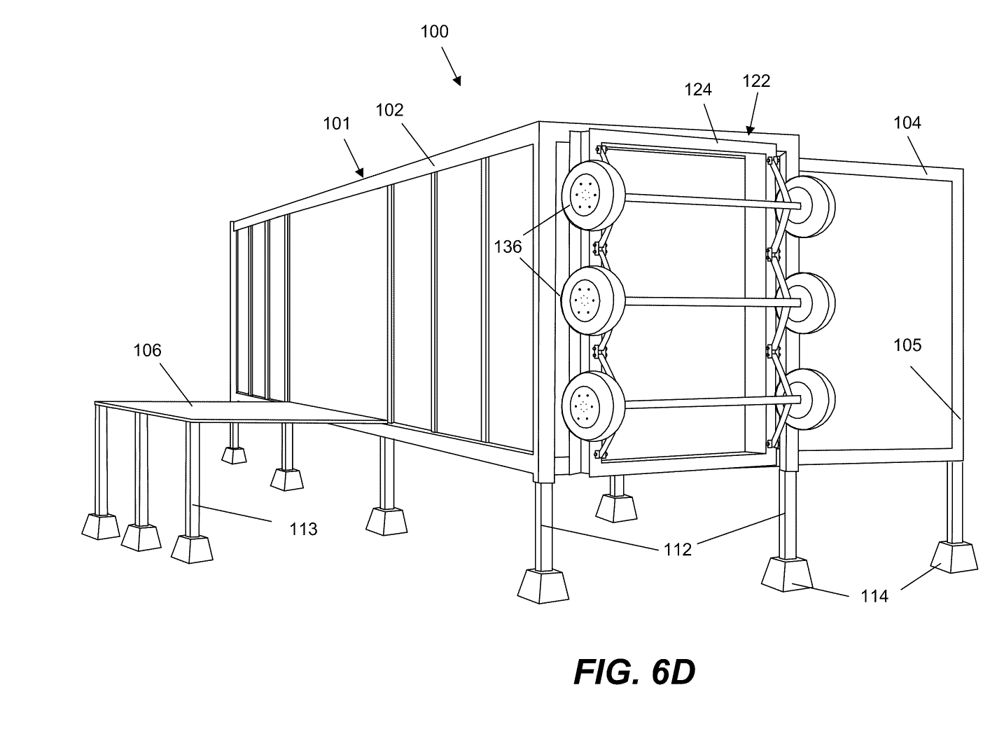

As shown in FIGS. 1 and 3A-3C, a hitch 166 extends from the second carriage 152 and is connectable with a vehicle for towing to a staging site. The prefabricated structure is suspended between the hitch 166 and the wheels 116. Prefabricated structures such as described in U.S. Ser. No. 12/250,467 and further shown in FIGS. 5-6D can comprise support posts 112 that are extendable from a column of the frame 102 and joinable with a concrete base anchored by rebar driven into the ground to fix the prefabricated structure in place. A distance from which the support posts 112 extend from the column of the frame 102 can be adjusted vertically so that the prefabricated structure 100 can be leveled. In embodiments where the prefabricated structure is suspended between the hitch 166 and the wheels 136, the support posts 112 can be retractably lowered to support the prefabricated structure 100 as the hitch 166 is connected with a vehicle for towing or separated from a vehicle after towing.

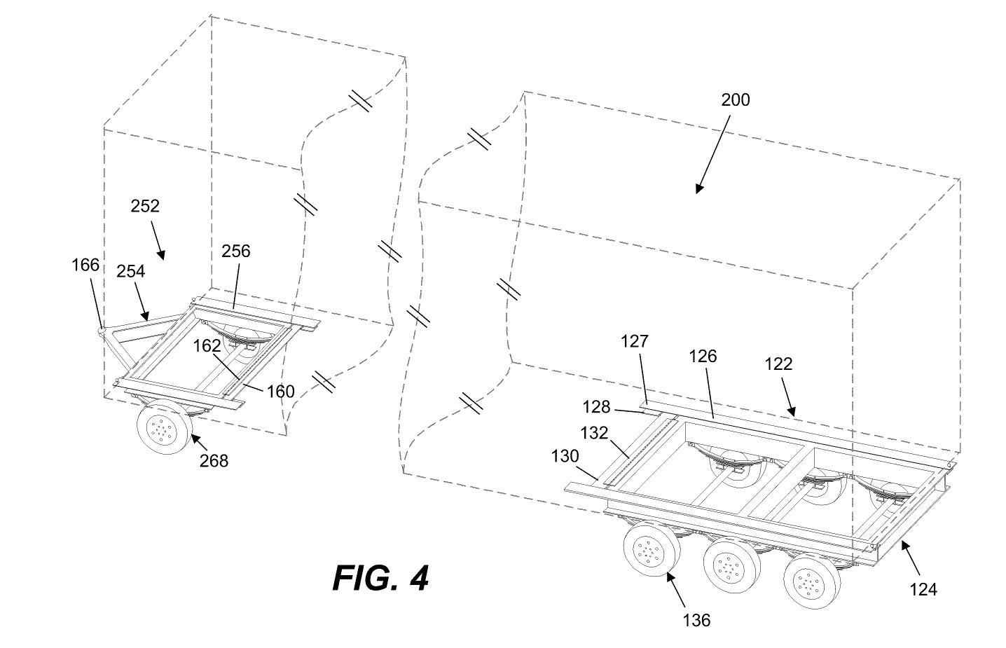

Referring to FIG. 4, in other embodiments one or more pairs of wheels 268 can be connected with the second carriage 252 to support the prefabricated structure 200 when the hitch 166 is engaged and when the hitch 166 is not engaged. As shown, the carriage frame 254 includes is lengthened to accommodate a length of leaf springs connecting the wheels 268 to the carriage frame 254. Likewise, the second pair of guide rails 256 is extended in length.

FIG. 5 is a perspective view of an embodiment of a deployable, prefabricated structure 300 in accordance with the present invention comprising a shell 101 with a frame 102 and an extension 104 nestable within the frame 102 of the shell 101. The prefabricated structure 300 is shown with the extension 104 deployed and support posts 112 extending from columns 108 of the frame 102. As mentioned above, the prefabricated structure 300 resembles deployable, prefabricated structures of U.S. Ser. No. 12/250,467. However, the prefabricated structure 300 further comprises a first carriage 352 including a hitch 366 that can be joined with a vehicle for transporting the prefabricated structure, and a second carriage 122 including a set of wheels 136 connected with a second carriage frame 124 for supporting the prefabricated structure 300 during transport. A length of the frame 102 extends between the first carriage and second carriage, and a width of the frame 102 extends along a hinge connecting the first carriage and the second carriage to the prefabricated structure. As shown, the first carriage 352 and second carriage 122 extend out from guide rails (not shown) and can be rotated relative to the prefabricated structure 300. Rotating the carriages 122, 352 allows the carriages 122, 352 to be stowed so as to not interfere with stacked transport of the prefabricated structure 300. Shipping containers transported by cargo ship or flatbed are commonly stacked to increase the number of shipping containers transportable. Embodiments of prefabricated structures in accordance with the present invention can be transformably transportable in a stacked configuration or a towed configuration. It is noted that the hitch 366 and second carriage frame 354 of FIG. 5 have an alternative construction relative to previous embodiments. One of ordinary skill in the art, upon reflecting on the teaches provided herein, will appreciate the myriad different geometries, construction techniques, and features with which carriages for use with embodiment of prefabricated structures in accordance with the present invention can be formed.

Referring again to FIGS. 2A-3C, one or both pairs of guide rails 126, 156 can extend lengthwise along the prefabricated structure beyond the carriage stop 129, 159. The pair of guide rails 126, 156 can terminate so that the channel of the pair of guide rails 126, 156 is accessible from a direction opposite the carriage stop 129, 159 from the carriage 122, 152. The pair of guide rails 126, 156 can receive a pallet skid 142, 172 within the channel, which pallet skid 142, 172 can removably fix the prefabricated structure 100 for transport on a pallet.

Referring to FIGS. 6A-6D, an embodiment of a prefabricated structure 100 and a method of deploying the prefabricated structure 100 at a target site in accordance with the present invention are shown. The prefabricated structure 100 can be transported to a staging site by towing the prefabricated structure 100 by hitch 166 and wheel 136. Once the prefabricated structure 100 is delivered to the staging site, a forklift, crane, or other positioning tool can suspend the prefabricated structure 100 while the first carriage 122 connected with the wheels is collapsed against a side of the prefabricated structure 100 and a second carriage 152 connected with the hitch 166 is collapsed against an opposite side of the prefabricated structure 100. The first carriage 122 and second carriage 152 can be collapsed as described above in FIGS. 2A-3C, with the carriages 122, 152 being urged along respective guide rails 126, 156 until the carriage frames 124, 154 disengage the respective guide rails 126, 156. Locking pins are positioned within channels of the guide rails 126, 156 between the carriage frames 124, 154 and an anchor plate (not shown). The carriage frames 124, 154 are then pivoted so that the carriage frames 124, 154 can be detachably connected with the sides of the prefabricated structure 100, substantially perpendicular to the previous orientation of the carriage frames 124, 154.

Referring to FIG. 6A, the prefabricated structure 100 can be delivered to the target site for installation. A forklift can provide sufficient accuracy in positioning while raising and/or lowering the prefabricated structure 100 to an appropriate height for anchoring. Referring to FIGS. 6B and 6C, the prefabricated structure 100 is fixed in place by support posts 112 lowered from columns 108 of the frame 102 and joined with concrete bases 114 anchored by rebar driven into the ground. Once the support posts 112 are lowered, the forklift can be withdrawn. The support posts 112 can be adjusted vertically so that the prefabricated structure 100 is sufficiently leveled. Existing techniques for determining leveling can be applied to assist adjustment of the vertical deployment of the support posts 112 from the frame of the shell 101. The prefabricated structure 100 can be deployed in stages so that the support posts 112 can be extended and fixed in a systematic fashion.

Once the shell 101 is anchored, the extension 104 can be extended from a nested position within the shell 101, as shown in FIG. 6D. Support posts 112 of the extension 104 are then lowered from columns 105 of the extension 104 and joined with concrete bases 114 anchored by rebar driven into the ground. A deck, which in FIG. 6A-6D extends a portion of the length of the shell 101, can then be lowered and supported by anchored support posts 113 which can be stored within the prefabricated structure 100, or alternatively are delivered separate from the prefabricated structure 100.

Embodiments of prefabricated structures and methods of deploying prefabricated structures in accordance with the present invention have been described with reference to a limited number of frame configurations and features. One of ordinary skill in the art will appreciate, in light of the included drawings and descriptions, as well as the drawings and descriptions of U.S. Ser. No. 12/250,467, the myriad different embodiments of prefabricated structures with which repositionable carriages described herein can be used.

The foregoing description of the present invention has been presented for purposes of illustration and description. It is not intended to be exhaustive or to limit the invention to the precise forms disclosed. Many modifications and variations will be apparent to practitioners skilled in this art. The embodiments were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

1. A portable, prefabricated structure comprising:
a frame;
a first pair of guide rails extending below the frame and along at least a portion of a length of the frame, each guide rail including a channel;
a first carriage stop within a channel of one or both of the guide rails of the first pair of guide rails;
a first carriage including at least one pair of wheels connected with the first carriage and a carriage lip received within the channels of the first pair of guide rails, the first carriage movably associated with the first pair of guide rails by urging the carriage lip along the channels;
a first anchor connected to the first carriage by a hinge, the first anchor movable with the first carriage by urging the first anchor along the channels of the first pair of guide rails;
wherein when configured for transport by way of the wheels, the first anchor is urged against the first carriage stop;
wherein when deployed at a target site, the first carriage is extendable outside of the channels of the first pair of guide rails and the first anchor is lockable within the channels by at least one first stop pin;
wherein when extended outside of the first track, the first carriage is rotatable about the hinge;
a second pair of guide rails extending below the frame and along at least a portion of a length of the frame, each guide rail including a channel;
a second carriage stop within a channel of one or both of the guide rails of the second pair of guide rails;
a second carriage including a hitch extending from the second carriage and a carriage lip received within the channels of the second pair of guide rails, the second carriage movably associated with the second pair of guide rails by urging the carriage lip along the channels;
a second anchor connected to the second carriage by a hinge, the second anchor movable with the second carriage by urging the second anchor along the channels of the second track;
wherein when configured for transport by way of the wheels, the second anchor is urged against the second carriage stop;
wherein when deployed at a target site, the second carriage is extendable outside of the channels of the second pair of guide rails and the second anchor is lockable within the channels by at least one second stop pin; and
wherein when extended outside of the second track, the second carriage is rotatable about the hinge.

2. The portable, prefabricated structure of claim 1, wherein:
a first pallet skid is receivable within the first pair of guide rails so that when transported on a pallet, the first pallet skid is urged against the first carriage stop; and
a second pallet skid is receivable within the second pair of guide rails so that when transported on the pallet, the second pallet skid is urged against the second carriage stop.

3. The portable, prefabricated structure of claim 1, wherein the first anchor is a first plate and the second anchor is a second plate.

4. The portable, prefabricated structure of claim 1, wherein the first pair of guide rails is welded to the frame and extends beyond the frame so that the at least one first stop pin is accessible.

5. The portable, prefabricated structure of claim 1, wherein:
the first carriage is disassociatable from the frame by urging the first anchor out of the channels of the first pair of guide rails; and
the second carriage is disassociatable from the frame by urging the second anchor out of the channels of the second pair of guide rails

6. The portable, prefabricated structure of claim 1, wherein the at least one pair of wheels is connected with the first carriage by a leaf spring suspension.

7. The portable, prefabricated structure of claim 1, wherein when the first carriage and second carriage are rotated so that the first carriage and second carriage contact vertical sides of the frame, the frame is transportable on a flat car and/or stackable on a second frame.

8. The portable, prefabricated structure of claim 1, wherein a guide rail from the first pair and the second pair of guide rails further comprises a primary plate fixedly connected with the frame and a secondary plate gapped from the primary plate, which gap defines the channel.

9. The portable, prefabricated structure of claim 1, wherein the frame further comprises:
a shell including a shell frame comprising:
a floor support including:
a pair of floor beams extending lengthwise along the shell,
a plurality of slotted beams extending between and transverse to the floor beams, and
a floor joist extending between and transverse to the floor beams and arranged between the slotted beams;
a roof support including:
a first pair of roof beams extending lengthwise along the shell, and
a second pair of roof beams extending between and transverse to the first pair of roof beams; and
a plurality of columns extending between the floor support and the roof support; and an extension deployable from the shell, the extension including an extension frame comprising:
a floor support including:
a main floor beam extending lengthwise along the extension,
a pair of extension floor beams extending from the main floor beam toward the shell and telescoping from corresponding slotted beams of the shell,
an extension joist extending from the main floor beam toward the shell and telescoping from the floor joist of the shell;
a wall base coplanar with the extension joist and gapped from the extension joist so that the wall base is received over the floor joist when the extension is seated within the shell;
a roof support including:
a pair of roof beams extending lengthwise along the extension, and
a pair of roof joists extending between and transverse to the first pair of roof beams; and
a plurality of columns extending between the floor support and the roof support;
wherein the slotted beams of the shell floor support each include a slot through which a column connected between an extension floor beam and an extension roof extends when the extension is nested within the shell in an undeployed position.

10. The portable, prefabricated structure of claim 1, further comprising:
an assembly for deploying the extension including:
a shaft extending lengthwise along at least a portion of the shell,
a pinion operably associated with the shaft;
a rack communicating with the pinion and operably associated with one or more of the extension floor beams and the extension joist; and
a motor operable to rotate the shaft so that the extension is deployed.

11. A portable, prefabricated structure comprising:
a frame;
a pair of guide rails extending below the frame and along at least a portion of a length of the frame, each guide rail including a channel;
a carriage stop within the channels of the pair of guide rails;
a carriage including at least one pair of wheels connected with the carriage and a carriage lip received within the channels of the pair of guide rails, the carriage movably associated with the pair of guide rails by urging the carriage lip along the channels;
an anchor connected to the carriage by a hinge, the anchor movable with the carriage by urging the anchor along the channels of the pair of guide rails;
wherein when configured for transport by way of the wheels, the anchor is urged against the carriage stop; and
wherein when deployed at a target site, the carriage is extendable outside of the channels of the pair of guide rails and the anchor is lockable within the channels so that the carriage is rotatable at the hinge such that the carriage is substantially perpendicular to the pair of guide rails.

12. The portable, prefabricated structure of claim 11, further comprising:
a second pair of guide rails extending below the frame and along at least a portion of a length of the frame, each guide rail including a channel;
a second carriage stop within the channels of the second pair of guide rails;
a second carriage including a hitch extending from the second carriage and a carriage lip received within the channels of the second pair of guide rails, the second carriage movably associated with the second pair of guide rails by urging the carriage lip along the channels;
a second anchor connected to the second carriage by a hinge, the second anchor movable with the second carriage by urging the second anchor along the channels of the second track;
wherein when configured for transport by way of the wheels, the second anchor is urged against the second carriage stop;
wherein when deployed at a target site, the second carriage is extendable outside of the channels of the second pair of guide rails and the second anchor is lockable within the channels so that the second carriage is rotatable at the hinge such that the second carriage is substantially perpendicular to the second pair of guide rails.

13. The portable, prefabricated structure of claim 12, wherein:
a first pallet skid is receivable within the first pair of guide rails so that when transported on a pallet, the first pallet skid is urged against the first carriage stop; and
a second pallet skid is receivable within the second pair of guide rails so that when transported on the pallet, the second pallet skid is urged against the second carriage stop.

14. The portable, prefabricated structure of claim 12, wherein the first anchor is a first plate and the second anchor is a second plate.

15. The portable, prefabricated structure of claim 11, wherein the pair of guide rails is welded to the frame and extends beyond the frame so that at least one stop pin to lock the anchor in position is accessible.

16. The portable, prefabricated structure of claim 12, wherein:
the first carriage is disassociatable from the frame by urging the first anchor out of the channels of the first pair of guide rails; and
the second carriage is disassociatable from the frame by urging the second anchor out of the channels of the second pair of guide rails

17. The portable, prefabricated structure of claim 11, wherein the at least one pair of wheels is connected with the carriage by a leaf spring suspension.

18. The portable, prefabricated structure of claim 12, wherein when the first carriage and second carriage are rotated so that the first carriage and second carriage contact vertical sides of the frame, the frame is transportable on a flat car and/or stackable on a second frame.

19. The portable, prefabricated structure of claim 12, wherein a guide rail from the first pair and the second pair of guide rails further comprises a primary plate fixedly connected with the frame and a secondary plate gapped from the primary plate, which gap defines the channel.

20. A portable, prefabricated structure comprising:
a frame with a bottom and a side wall;
a carriage including at least one pair of wheels;
said carriage operatively associated with the frame; and
said carriage deployable between a first position adjacent the bottom in order to enable the frame to be transported and a second position adjacent to the side wall in order to store the carriage.

21. The structure of claim 20 wherein:
said carriage is slidably engaged with the bottom such that said carriage can slide from the first position to an interim position and from said interim position said carriage can pivot to said second position.

22. The structure of claim 20 includes a first carriage component which includes said pair of wheels and a second carriage component that is pivotably connected to the first carriage component: and
wherein said carriage is slidably engaged with the bottom such that carriage can slide from the first position to an interim position where the first carriage component extends past said bottom, and from said interim position said first carriage component can pivot to said second position adjacent to the side wall.

23. A portable, prefabricated structure comprising:
a frame with a bottom and a side wall;
a carriage including a hitch;
said carriage operatively associated with the frame; and
said carriage deployable between a first position adjacent the bottom in order to enable the frame to be transported and a second position adjacent to the side wall in order to store the carriage.

24. The structure of claim 23 wherein:
said carriage is slidably engaged with the bottom such that said carriage can slide from the first position to an interim position and from said interim position said carriage can pivot to said second position.

25. The structure of claim 23 includes a first carriage component which includes said hitch and a second carriage component that is pivotably connected to the first carriage component: and
wherein said carriage is slidably engaged with the bottom such that carriage can slide from the first position to an interim position where the first carriage component extends past said bottom, and from said interim position said first carriage component can pivot to said second position adjacent to the side wall.
